(19) United States
(12) Patent Application Publication
(10) Pub. No.: US 2026/0132827 A1
(43) Pub. Date: May 14, 2026

(54) ELECTROMECHANICAL BRAKE WITH FLEXIBLE SPINDLE

(71) Applicant: Robert Bosch GmbH, Stuttgart (DE)

(72) Inventor: Matthias Greiner, Simmozheim (DE)

(21) Appl. No.: 19/379,246

(22) Filed: Nov. 4, 2025

(30) Foreign Application Priority Data
Nov. 13, 2024 (DE) 10 2024 210 866.9

(51) Int. Cl. F16D 55/2265; F16D 65/18; F16D 121/24; F16D 125/40

(52) U.S. Cl. CPC F16D 55/2265; F16D 65/18; F16D 2121/24; F16D 2125/40

(57) ABSTRACT

An electromechanical brake for a motor vehicle. The electromechanical brake includes an electric motor which rotationally drives a spindle of a spindle drive unit arranged in a brake caliper housing, so that, in order to apply a braking force, a spindle nut is movable in an axial direction of the brake caliper housing. A flexible region is formed on the spindle, which flexible region has an increased radial flexibility compared to the rest of the spindle, so that the spindle, when subject to radial forces, undergoes radial bending at the spindle nut.

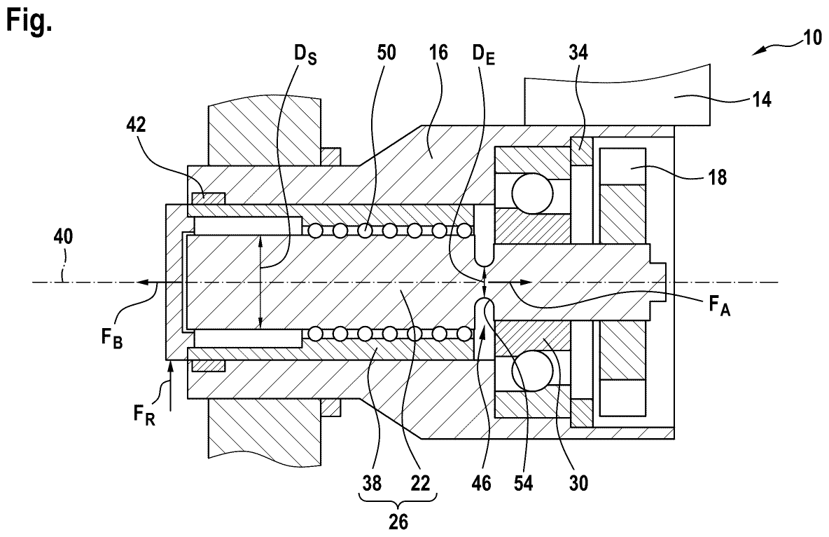

### FIELD

The present invention relates to an electromechanical brake for a motor vehicle. In addition, the present invention relates to a motor vehicle having such an electromechanical brake.

### BACKGROUND INFORMATION

The service brake is usually a brake that uses brake fluid to press a brake piston, together with a brake pad, onto a brake disk in order to brake the vehicle. Amid the increasing electrification of constituent units in the motor vehicle, the service brake is also to be formed as an electromechanical brake so that the need for brake fluid and the associated complex valve and line structure can be eliminated. Such an electromechanical brake could also significantly reduce maintenance requirements.

Germany Patent Application No. DE 10 2010 029 856 A1 describes an electromechanically actuatable disk brake for a motor vehicle. The brake comprises an electric motor which drives a spindle nut of a spindle drive unit via a gearbox unit. A spindle for braking can be moved axially via the driven spindle nut. The spindle presses against a brake piston which is guided in a brake caliper housing. A connecting piece is arranged between the spindle and the brake piston, which connecting piece forms a ball socket for a spherical end of the spindle. This connecting piece allows tilting within the housing without applying a transverse force to the spindle drive unit. Germany Patent No. DE 19 607 295 C1 describes a brake actuator for an electric vehicle brake. The vehicle brake comprises an electric motor which has a stator and a rotor connected to the spindle nut of a spindle drive arrangement. The spindle can be moved in an axial direction by rotating the spindle nut. A sliding bearing is arranged between the spindle and a brake piston, by means of which lateral forces on the spindle unit are reduced.

A problem addressed by the present invention is that of specifying an electromechanical brake that has a longer lifespan.

The problem is solved by an electromechanical brake having certain features of the present invention. Preferred embodiments are disclosed herein.

### SUMMARY

The present invention provides an electromechanical brake for a motor vehicle. According to an example embodiment of the present invention, the electromechanical brake comprises an electric motor which rotationally drives a spindle of a spindle drive unit arranged in a brake caliper housing, so that, in order to apply a braking force, a spindle nut is movable in an axial direction of the brake caliper housing. A flexible region is formed on the spindle, which flexible region has an increased radial flexibility compared to the rest of the spindle, so that the spindle, when subject to radial forces, undergoes radial bending at the spindle nut.

A flexible region within the meaning of the present invention is understood to be a locally limited region which has a lower bending stiffness. The flexible region is located between the two axial ends of the spindle. The flexible region is therefore not formed at an axial end of the spindle. When bending stiffness is lower, radial bending of the flexible region is therefore greater when subject to the same radial force. The flexible region therefore allows tilting of the spindle when subject to radial forces. Due to the tilting, the spindle nut comes into lateral contact with the brake caliper housing, so that the majority of the radial force is transmitted directly into the brake caliper housing. As a result, the radial force absorbed by the spindle drive unit is significantly reduced, so that wear of the spindle drive unit due to tilting in the thread can be significantly reduced. This improves the durability of the spindle drive unit and therefore also that of the electromechanical brake. Accordingly, a longer lifespan can be achieved.

In a preferred embodiment of the present invention, the flexible region of the spindle is designed to have a reduced diameter compared to the rest of the spindle. By reducing the diameter in the flexible region, the bending stiffness is automatically reduced, so that the spindle has more flexible properties in this region. A reduced diameter has the advantage that the spindle can still be made from the same material, a reduced diameter only being formed in a limited region. Accordingly, a formation of such a region is economically feasible.

In a further preferred embodiment of the present invention, the flexible region has a diameter that is 20-60% smaller than the rest of the spindle. Particularly preferably, the flexible region has a diameter that is 30-50% smaller. Such a change in diameter results in a significant change in the flexibility of the spindle compared to the rest of the spindle, so that the spindle, together with the spindle nut, can be tilted by bending in the flexible region.

A rounded region is preferably formed in a transition region between the reduced diameter and a diameter of the rest of the spindle. Therefore, there is no abrupt increase in diameter between the reduced diameter and the diameter of the rest of the spindle. The rounded region therefore reduces the stresses between the different diameters. The rounded region therefore improves the durability of the spindle.

In an advantageous further development of the present invention, the flexible region is provided adjacent to a bearing point of the spindle and on a side of the spindle facing the spindle nut. The bearing point is a point that is furthest from an axial end of the spindle nut. Bending of the flexible region can be reduced to a minimum by the distance. Accordingly, such an arrangement can increase the lifespan of the spindle and therefore also that of the electromechanical brake.

As a result of such an arrangement of the flexible region, this region therefore does not need to be located in the region of the thread of the spindle drive unit. A function and the operation of the spindle drive unit are therefore not adversely affected by the flexible region.

According to an example embodiment of the present invention, advantageously, at least one guide element is arranged in the brake caliper housing, by means of which the spindle nut is guided radially. This guide element is designed in such a way that it transmits a radial force from the spindle nut into the brake caliper housing. Such a guide element can ensure frictionless guidance of the spindle nut even when subject to a radial load. Advantageously, the guide element is arranged in a front end region of the brake caliper housing. In this region, the spindle nut has the smallest distance to the brake caliper housing. The guide element prevents the spindle nut from coming into direct contact with the brake caliper housing in this region, so that wear of the spindle nut can be prevented.

In a further advantageous embodiment of the present invention, the spindle drive unit is a ball screw drive. A ball screw drive has the advantage that, compared to a spindle screw drive, it has reduced friction in the thread, which increases the lifespan. Furthermore, a smaller electric motor is required for such a ball screw drive.

The present invention additionally specifies a motor vehicle having such an electromechanical brake. With such a motor vehicle, the advantages and properties described above are achieved.

Exemplary embodiments of the present invention are illustrated in the figure and explained in more detail in the following description.

### BRIEF DESCRIPTION OF THE DRAWING

FIG. is a longitudinal sectional view of an electromechanical brake according to an exemplary embodiment of the present invention.

### DETAILED DESCRIPTION OF EXAMPLE EMBODIMENTS

The figure is a longitudinal sectional view of an electromechanical brake 10 according to an exemplary embodiment of the present invention. The electromechanical brake 10 comprises an electric motor 14 which is arranged on a brake caliper housing 16 of the electromechanical brake 10. The electric motor 14 drives a worm gear 18 via a worm (not shown here). The worm gear 18, which is arranged in the brake caliper housing 16, is attached to a spindle 22 of a spindle drive unit 26. In the exemplary embodiment shown here, the spindle drive unit 26 is designed as a ball screw drive. Accordingly, the spindle 22 can be rotated by rotating the worm gear 18.

The spindle 22 is mounted in the brake caliper housing 16 via a bearing point 30 designed as an angular-contact ball bearing. To be able to absorb axial forces F_{A} of the angular-contact ball bearing 30, a ring 34 is fastened in the brake caliper housing 16. By rotating the spindle 22, a spindle nut 38 of the spindle drive unit 26 can be moved in an axial direction 40 in the brake caliper housing 16. The spindle nut 38 is guided by a guide element 42 arranged in the brake caliper housing 16. Accordingly, a braking force F_{B} can be applied to an axial end of the spindle nut 38 via the spindle nut 38.

Adjacent to the bearing point designed as an angular-contact ball bearing 30, the spindle 22 has a flexible region 46 which is designed in the form of a reduced diameter D_{E}. The diameter D_{E} of the flexible region is significantly smaller than a diameter D_{S} of the rest of the spindle 22. In the event of a radial force F_{R} on the spindle nut 38, the flexible region 46 allows radial bending of the spindle 22 so that the spindle 22 and spindle nut 38 are tilted. This makes it possible for the spindle nut 38 to be pressed against the brake caliper housing 16 in the case of a radial force FR, so that the radial force F_{R} is absorbed by the brake caliper housing 16. This reduces the load on the spindle drive unit 26, since a lower radial force F_{R} must be absorbed by balls 50 of the spindle drive unit 26.

The flexible region 46 having the reduced diameter D_{E} has a rounded region 54 between the reduced diameter D_{E} and the diameter D_{S} of the rest of the spindle 22. This rounded region 54 can reduce notch effects in the region of the reduced diameter 46. Accordingly, the durability of the spindle 22 can be increased.

1-8. (canceled)

9. An electromechanical brake for a motor vehicle, comprising:
an electric motor which rotationally drives a spindle of a spindle drive unit arranged in a brake caliper housing, so that, to apply a braking force, a spindle nut is movable in an axial direction of the brake caliper housing;
wherein a flexible region is formed on the spindle, the flexible region having an increased radial flexibility compared to the rest of the spindle, so that the spindle, when subject to radial forces, undergoes radial bending at the spindle nut.

10. The electromechanical brake according to claim 9, wheeein the flexible region of the spindle is formed with a reduced diameter compared to the rest of the spindle.

11. The electromechanical brake according to claim 10, whereub the flexible region has a diameter which is 20-60% smaller than the rest of the spindle.

12. The electromechanical brake according to claim 10, wherein, in a transition region between the reduced diameter and a diameter of the rest of the spindle, a rounded region is formed.

13. The electromechanical brake according to claim 9, wherein the flexible region is provided adjacent to a bearing point of the spindle and on a side of the spindle facing the spindle nut.

14. The electromechanical brake according to claim 9, wherein, in the brake caliper housing, at least one guide element is arranged, wherein using the at least one guide element, the spindle nut is guided radially.

15. The electromechanical brake according to claim 9, wherein the spindle drive unit is a ball screw drive.

16. A motor vehicle, comprising:
an electromechanical brake, including:
an electric motor which rotationally drives a spindle of a spindle drive unit arranged in a brake caliper housing, so that, to apply a braking force, a spindle nut is movable in an axial direction of the brake caliper housing,
wherein a flexible region is formed on the spindle, the flexible region having an increased radial flexibility compared to the rest of the spindle, so that the spindle, when subject to radial forces, undergoes radial bending at the spindle nut.
